(19) United States
(12) Patent Application Publication
(10) Pub. No.: US 2025/0337265 A1
(43) Pub. Date: Oct. 30, 2025

(54) STARTUP CONTROL OF GENERATOR

(71) Applicant: Volvo Car Corporation, Göteborg (SE)

(72) Inventors: Jones Schöld, Göteborg (SE); Vijay Arumugam, Västra Frölunda (SE); Emir Köse, Göteborg (SE); Ali Fotouhi, Kungsbacka (SE)

(73) Assignee: Volvo Car Corporation, Göteborg (SE)

(21) Appl. No.: 19/188,010

(22) Filed: Apr. 24, 2025

(30) Foreign Application Priority Data
Apr. 26, 2024 (EP) 24172733.8

(51) Int. Cl. H02J 7/00

(52) U.S. Cl. CPC H02J 7/00716; H02J 7/00032; H02J 7/0036; H02J 7/007182

(57) ABSTRACT

A control unit for controlling an electric power supply device being configured for power supply between an energy storage and a power grid supplying electric power to a connection point, the control unit configured to receive first data indicative of if the energy storage is connected to the electric power supply device, detect that the energy storage is connected to the electric power supply device, after detecting that the energy storage is connected, obtain second data indicative of a frequency and a voltage of an exchanged electric power at the connection point for an observation period, determine, if both the frequency has been maintained within frequency limitations, and the voltage has been maintained within voltage limitations during the observation period, and, provide a startup control signal to the electric power supply device indicating that the energy storage is allowed to exchange electric power with the power grid.

### CROSS REFERENCE TO RELATED APPLICATIONS

This application claims the benefit of European Patent Application Number 24172733.8 filed on Apr. 26, 2024, which is hereby incorporated by reference in its entirety.

### TECHNICAL FIELD

The present disclosure relates to a control unit and a method for controlling an electric power supply device, the electric power supply device being configured for power supply between an energy storage and a power grid which supplies electric power to a connection point.

### BACKGROUND

Electric power supply devices shall observe the power grid quality for a certain period before allowing power feed-in to the power grid. This shall happen every time the electric power supply device starts up. Typical solar hybrid inverter and battery inverter stays at one place and is always connected to the power grid. But electric vehicle and/or other kind of devices with energy storage can connect and disconnect several times in a day because the customer may use the electric vehicle for transportation. Implementing this requirement in electric vehicles will result in a poor charging experience for customer because every time the customer connects the electric vehicle, it is needed to wait for this function to be performed before allowing charging or discharging. This results in a poor charging experience for customers.

### SUMMARY

The following paragraphs present a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

According to an embodiment, a control unit is provided, the control unit for controlling an electric power supply device, the electric power supply device being configured for power exchange between an energy storage and a power grid which supplies electric power to a connection point, the control unit being configured to receive first data indicative of if the energy storage is connected to the electric power supply device, detect, using the first data, that the energy storage is connected to the electric power supply device, obtain second data indicative of a frequency and a voltage of an exchanged electric power at the connection point for an observation period, determine, using the second data, if both the frequency has been maintained within frequency limitations, and the voltage has been maintained within voltage limitations during the observation period, and provide a startup control signal to the electric power supply device indicating that the energy storage is allowed to exchange electric power with the power grid.

This allows the energy storage to start exchanging electric power with the power grid as soon as the energy storage is connected to the electric power supply if the voltage and frequency have been maintained within the frequency and voltage limitations for the observation period, thereby avoiding waiting time when the energy storage is connected because the observation was already carried out by the electric power supply device which stays connected all the time. To detect, using the first data, that the energy storage is connected to the electric power supply device, the electric power supply device may be continuously monitor whether the energy storage is plugged-in to the electric power supply device. For instance, as soon as the energy storage is plugged-in to the electric power supply device, certain signals should be received at the electric power supply device through a communication line between the energy storage and the electric power supply device.

According to an aspect, the control unit is connected through a communication line with the energy storage.

According to another embodiment, a method for controlling an electric power supply device is provided, the electric power supply device being configured for power exchange between an energy storage and a power grid which supplies electric power to a connection point, the method comprising receiving first data indicative of if the energy storage is connected to the electric power supply device, detecting, using the first data, that the energy storage is connected to the electric power supply device, determining, using the second data, if both the frequency has been maintained within frequency limitations, and the voltage has been maintained within voltage limitations, for an observation period, and providing a startup control signal to the electric power supply device indicating that the energy storage is allowed to exchange electric power with the power grid.

If the second data indicates that the frequency of the power grid has not been maintained within the frequency limitations for the observation period, the startup control signal may indicate that the energy storage should supply power to the power grid and not draw power from the power grid for a first waiting period, or draw power from the power grid and not supply power to the power grid for a second waiting period. That is, if the second data indicates that the power grid is in an abnormal state and needs reinforcement (by adding loads or generation of power depending on the frequency of the power grid) to restore the frequency of the power grid. In this situation, the startup control signal for the newly connected energy storage may indicate that the energy storage should supply power to the power grid and not draw power from the power grid, or draw power from the power grid and not supply power to the power grid, until the frequency of the power grid is restored.

According to an aspect, the energy storage is configured to restore the frequency at the power grid when the frequency is above the higher frequency threshold.

In this way, the first waiting period and the second waiting period may be based on a time needed for the power grid to be restored such that the frequency is again within the frequency limitations. For instance, the control unit may be continuously monitoring the power grid and, when the control unit detects that the frequency of the power grid is again within the frequency limitations, the control unit may generate a startup signal indicating that the energy storage is allowed to exchange electric power with the power grid.

In this way, the energy storage will be able to connect and immediately start to help the power grid on restoring the frequency to be within the frequency limitations.

According to an aspect, wherein electric power supply device is configured to continuously monitor the frequency and voltage of the exchanged electric power at the connection point.

The second data indicative of the frequency and the voltage of the exchanged electric power at the connection point for the observation may be obtained based on a plurality of frequency and voltage measurements of the exchanged electric power taken during the observation period.

The frequency may have been maintained within the frequency limitations if an average of the plurality of frequency measurements is between a higher frequency threshold and a lower frequency threshold, or if a number of the plurality of measurement are between the higher frequency threshold and the lower frequency threshold.

The voltage may have been maintained within the voltage limitations if an average of the plurality of voltage measurements is between a higher voltage threshold and a lower voltage threshold, or if another number of the plurality of voltage measurements are between the higher voltage threshold and the lower voltage threshold.

If the average of the plurality of frequency measurements and/or at least one of the plurality of frequency measurements is above the higher frequency threshold, the startup control signal indicates that the energy storage should, for the second waiting period, draw power from the power grid and not supply power to the power grid.

By drawing power from the power grid, the energy storage acts as a load to the power grid thereby helping to reducing the power grid frequency. This allows the energy storage to help restore the frequency at the power grid when said frequency is above the higher frequency threshold.

If the average of the plurality of frequency measurements and/or at least one of the plurality of frequency measurements is below the lower frequency threshold, the startup control signal indicates that the energy storage should, for the first waiting period, supply power to the power grid and not draw power from the power grid.

By supplying power from the energy storage to the power grid, the energy storage unit will help to improve the power grid frequency. This allows the energy storage to help restoring the frequency of the power at the power grid when said frequency is below the lower frequency threshold.

In this way, the power grid has the possibility to reach a stable situation faster, and the energy storage will be allowed to exchange power with the power grid in any convenient way for the energy storage after the power grid situation is again stable.

The plurality of frequency and voltage measurements may have been taken by a measurement device connected to the connection point or by the electric power supply device.

The electric power supply device and/or the measurement device may continuously be taken measurement of frequency and voltage of exchanged power. For instance, the electric power supply device and/or the measurement device may perform a frequency and voltage measurement at every 1 second or at any other suitable rate. If the measurement device is performing the measurements, the measurement device will send those measurements to the electric power supply device. The electric power supply device may store in an internal memory the measured voltage and frequency and, upon detecting that the energy storage is connected to the electric power supply device, may calculate, based on the stored measurements whether the frequency and/or the voltage have been maintained within frequency and/or voltage limitations for an observation period prior to the connection of the energy storage. For instance, if the observation period is of 60 seconds and measurements are taken at every 1 second, the electric power supply device may store the last performed 60 measurements in a memory such that, upon detection of connection of the energy storage, those 60 stored measurements will be used to detect whether the frequency and the voltage are within the required limitations. For instance, the average of the 60 measurements may be calculated and, if said average is within a higher and a lower frequency threshold, the control unit of the electric power supply device will detect that the frequency of exchanged power at the power grid is within the frequency limitations.

According to an aspect, the frequency and voltage are measured inside the electric power supply device by one of a power board measuring circuit and a measurement device.

Instead of storing the measurements, the electric power supply device may update a status variable stored in the memory. For instance, the electric power supply device may change the status variable based on whether the frequency and/or voltage has been maintained within the frequency and/or voltage limitations.

The electric power supply device may be configured for bidirectional power supply between the energy storage and the power grid and, if both the frequency has been maintained within the frequency limits, and the voltage has been maintained within the voltage limits for the observation period, the startup control signal indicates that the energy storage is allowed to bidirectionally exchange electric power with the power grid.

The first waiting period and the second waiting period may be equal to the time needed by the power grid to restore the frequency within the frequency limitations.

The energy storage may be arranged at an electric vehicle.

The observation period may comprise a period before detecting that the energy storage is connected to the electric power supply device. The electric power supply device may stay connected to the power grid and may monitor the power grid continuously. The startup control signal is sent to the energy storage as soon as the energy storage is connected to the electric power supply device to indicate which action is allowed.

The higher frequency threshold may be greater than the lower frequency threshold and/or the higher voltage threshold may be greater than the lower voltage threshold.

According to an aspect, the control unit further comprising a central processing unit connected to a memory unit and a communication unit.

According to another embodiment, an electric vehicle power supply device comprising the control unit is provided.

An electric vehicle comprising an electric power supply device, wherein the electric power supply device further comprising a control unit for controlling the electric power supply device, wherein the control unit is configured to: receive first data indicative of when an energy storage is connected to an electric power supply device; detect, using the first data, that the energy storage is connected to the electric power supply device; obtain second data indicative of a frequency and a voltage of an exchanged electric power at a connection point for an observation period; determine, using the second data, that both the frequency has been maintained within frequency limitations, and the voltage has been maintained within voltage limitations during the observation period; provide a startup control signal to the electric power supply device indicating that the energy storage is allowed to exchange electric power with a power grid; wherein the control unit is used for controlling the electric power supply device; wherein the electric power supply device is configured for power supply between an energy storage and power grid; and wherein the power grid is used for supplying electric power to the connection point.

According to an aspect, the electric vehicle comprising a Direct Current to Alternate current converter.

The higher frequency threshold may be between 65 Hertz's and 45 Hertz's, preferably between 52 Hertz's and 50 Hertz's. However, the higher frequency threshold may be any other suitable value.

The lower frequency threshold may be between 45 Hertz's and 65 Hertz's, preferably between 47 Hertz's and 50 Hertz's. However, the lower frequency threshold may be any other suitable value.

The higher voltage threshold may be between a 100 percent and a 110 percent of a nominal value of the voltage. The lower voltage threshold may be between a 50 percent and a 100 percent of a voltage nominal value. For instance, for a voltage nominal value of 230 such as in Europe, the higher voltage threshold may be between 265.5 Volts and 230 Volts and/or the lower voltage threshold may be between 230 Volts and 115 Volts. However, the lower and/or the higher voltage threshold may be any other suitable value.

A method for controlling an electric power supply device comprising: receiving first data indicative of when the energy storage is connected to the electric power supply device; detecting, using the first data, that the energy storage is connected to the electric power supply device; obtaining second data indicative of a frequency and a voltage of an exchanged electric power at the connection point for an observation period; determining, using the second data, that both the frequency has been maintained within frequency limitations, and the voltage has been maintained within voltage limitations, for an observation period; providing a startup control signal to the electric power supply device indicating that the energy storage is allowed to exchange electric power with the power grid; wherein the electric power supply device is configured for power supply between an energy storage and power grid; and wherein the power grid is used for supplying electric power to the connection point.

The person skilled in the art will understand that the features described above may be combined in any way deemed useful.

### BRIEF DESCRIPTION OF THE DRAWINGS

The present disclosure will now be described in further detail with reference to the drawings that shows embodiments of the present disclosure:

FIG. 1 is a schematic of a system for charging and/or discharging an energy storage according to at least one example of the disclosure.

FIG. 2 is a flowchart of a method for charging and/or discharging an energy storage according to at least one example of the disclosure.

FIG. 3 is a schematic of a system for an electric power supply device comprising the control unit according to an example of the disclosure.

### DETAILED DESCRIPTION

Embodiments of the present disclosure will be described herein below with reference to the accompanying drawings. However, the embodiments of the present disclosure are not limited to the specific embodiments and should be construed as including all modifications, changes, equivalent devices and methods, and/or alternative embodiments of the present disclosure.

The terms such as “first” and “second” as used herein may modify various elements regardless of an order and/or importance of the corresponding elements, and do not limit the corresponding elements. These terms may be used for the purpose of distinguishing one element from another element. For example, a first element may be referred to as a second element without departing from the scope of the present disclosure, and similarly, a second element may be referred to as a first element.

The terms used in describing the various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

The term “vehicle” as used herein refers to a thing used for transporting people or goods. Automobiles, cars, trucks, or buses etc. are examples of vehicles. The term “vehicle” also includes electric vehicle (EV) powered by an electric motor that draws current from an on-vehicle energy storage device, such as a battery, which is rechargeable from an off-vehicle source, such as residential or public electric service or an on-vehicle fuel powered generator. The EV may be two or more wheeled vehicles manufactured for use primarily on public streets and roads. The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

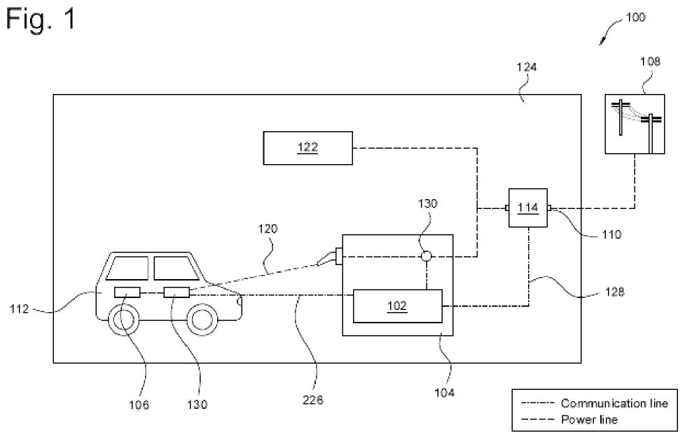

FIG. 1 is a schematic of a system 100 for charging an energy storage 106 according to at least one example of the disclosure.

The system 100 of FIG. 1 shows an electric vehicle 112 comprising an energy storage 106. The system 100 of FIG. 1 also shows an electric power supply device 104 connected to the power grid 108 via a connection point 110. The power grid 108 can be any kind of power grid configured to supply power to one or more loads or generators. For instance, the power grid 108 may be connected at connection point 110 of a house 124 and the house 124 may comprise the electric power supply device 104 and other loads and/or generators 122 belonging to the house 124 such that power exchange in both directions between the power grid 108 and house 124 can take place.

The energy storage 106 can be connected to and disconnected from the electric power supply device 104 via a power cable 120. In this way, when the energy storage 106 is connected to the electric power supply device 104, the energy storage 106 can supply power to the power grid 108 and can consume power from the power grid 108.

The electric vehicle 112 may comprise a Direct Current (DC) to Alternate Current (AC) (and AC to DC) converter, for instance as part of the power board measuring circuit 130. In this way, the electric power supply device 104 may act as a switch and allows the power to passthrough it in both directions.

The energy storage 106 is not allowed to startup when the power grid 108 is in disturbed state (meaning that frequency and voltage are not within frequency and voltage limitations imposed by the grid power supplier), this is to ensure the safety of the power grid 108 and avoid negative consequence in the power grid 108. With prior agreement with power system operators, the control unit 102 will allow the energy storage 106 to charge or discharge depending on the situation of the power grid 108 to support the power grid 108 in recovery. For this, the control unit 102 needs information about voltage and frequency measurements of the exchanged power at the connection point 110 of the power grid 108. Said voltage and frequency can be measured internally inside the electric power supply device 104 by the power board measuring circuit 130 or can be read from the measurement device 114.

The electric power supply device 104 comprises the control unit 102. The control unit 102 is configured to receive first data indicative of indicative of whether the energy storage 106 is connected to the electric power supply device 104. The control unit 102 is further configured to detect, using the first data, that the energy storage 106 is connected to the electric power supply device 104.

For instance, the control unit 102 may be connected through communication line 226 with the energy storage 106 such that the control unit 102 may receive a signal via communication line 226 as soon as the energy storage 106 is connected to the electric power supply device 104.

After detecting that the energy storage 106 has just been connected to the electric power supply device 104, the control unit 102 may obtain second data indicative of a frequency and a voltage of an exchanged electric power at the connection point 110. The control unit 102 may determine, using said second data, if the frequency has been maintained within frequency limitations and if the voltage has been maintained within voltage limitations during the observation period.

The second data indicative of the frequency and the voltage of the exchanged electric power at the connection point for the observation may be obtained based on a plurality of frequency and voltage measurements of the exchanged electric power taken during the observation period. The control unit may be continuously monitoring the power grid. For instance, the electric power supply device and/or the measurement device may continuously be taken measurement of frequency and voltage of exchanged power. The electric power supply device may store in an internal memory the measured voltage and frequency and, upon detecting that the energy storage is connected to the electric power supply device, may calculate, based on the stored measurements whether the frequency and/or the voltage have been maintained within frequency and/or voltage limitations for an observation period prior to the connection of the energy storage.

If the control unit 102 determines that both the frequency has been maintained within the frequency limitations, and the voltage has been maintained within voltage limitations for the observation period, the control unit 102 will provide a startup control signal to the electric power supply device 104 indicating that the energy storage 106 is allowed to exchange electric power with the power grid 108. The electric power supply device 104 may provide the startup signal to the electric vehicle 112 though the communication lines 226. Then the energy storage 106 may start charging power from the power grid 108 or start discharging power to the power grid 108.

If the second data indicates that the frequency of the power grid 108 has not been maintained within the frequency limitations for the observation period, the control unit 102 will generate a startup control signal indicating that the energy storage 106 should supply power to the power grid 108 and not draw power from the power grid 108 for a first waiting period, or draw power from the power grid 108 and not supply power to the power grid 108 for a second waiting period.

The control unit 102 may obtain the second data indicative of the frequency and the voltage of the exchanged electric power at the connection point 110 for the observation period based on a plurality of frequency and voltage measurements of the exchanged electric power taken during the observation period. The plurality of frequency and voltage measurements may be taken by the measurement device 114 which is connected to the connection point 110 and transmitted to the electric power supply device 104 via communication line 128. Alternatively, the electric power supply device 104 may be taken the plurality of frequency and voltage measurements using sensor 130.

The control unit 102 may detect that the frequency has been maintained within the frequency limitations by determining an average of the plurality of frequency measurements taken during an observation period prior to connecting the energy storage to the electric power supply device 104. If the calculated average is between a higher frequency threshold and a lower frequency threshold, the control unit 102 may decide that the frequency has been maintained within the frequency limitations.

Alternatively, the control unit 102 may detect that the frequency has been maintained within the frequency limitations by determining that a number of the plurality of measurement taken during the observation period are between a higher frequency threshold and a lower frequency threshold.

In the same way, if an average of the plurality of voltage measurements is between a higher voltage threshold and a lower voltage threshold, or if another number of the plurality of voltage measurements are between the higher voltage threshold and the lower voltage threshold, the control unit 102 may determine that the voltage has been maintained with the required voltage limitations.

If the average of the plurality of frequency measurements and/or at least one of the plurality of frequency measurements is above the higher frequency threshold, the control unit 102 may generate a startup control signal indicating that the energy storage 106 should, for the second waiting period, draw power from the power grid 108 and not supply power to the power grid 108.

In a similar way, if the average of the plurality of frequency measurements and/or at least one of the plurality of frequency measurements is below the lower frequency threshold, the control unit 102 may generate a startup control signal indicating that the energy storage 106 should, for the first waiting period, supply power to the power grid 108 and not draw power from the power grid 108.

In this way, the control unit 102 of the electric power supply device 104 decides the allowed operations of the energy storage 106 of the electric vehicle 112 based on the second data. The electric power supply device 104 may communicate the allowed operations to the electric vehicle 112 through communication lines 226 and using a communication protocol such as ISO15118-2 or ISO15118-20 or IEC61851 or DIN 70121. However, any other communication standard may be used to communicate the possible/allowed operation such as wireless, Bluetooth etc.

As it has been explained, the control unit 102, based on the received second data indicative of a frequency and a voltage of an exchanged electric power at the connection point 110 may determine the following operations for the electric vehicle 112.

If the control unit 102 determines that the power grid 108 is operating under normal conditions, meaning that both the voltage and frequency of an exchanged electric power at the connection point 110 are within allowed limitations, the control unit 102 shall provide a startup control signal to the electric power supply device 104 indicating that the energy storage 106 is allowed to bidirectionally exchange electric power with the power grid 108. In this way, the electric vehicle 112 is allowed to operate as desired immediately after plugin to the electric power supply device 104 if voltage and frequency were within the permissible range for the past observation period (i.e., charge or discharge allowed).

If the control unit 102 determines that the power grid 108 is operating under disturbed conditions, meaning the frequency of an exchanged electric power at the connection point 110 is not within the allowed limit, the control unit 102 shall provide a startup control signal to the electric power supply device 104 indicating that the following:

The control unit 102 shall provide a startup control signal allowing the electric vehicle 112 to charge the energy storage 106 immediately if the frequency is on the higher side of the nominal value (and the voltage is within the permissible range) which will help the power grid 108 to bring the frequency down by adding load to the power grid 108. That is, if the first data indicates that the frequency of the power grid 108 is above the higher frequency threshold, the startup control signal indicates that the energy storage 106 should, for the second waiting period, draw power from the power grid 108 and not supply power to the power grid 108, allowing charging the energy storage 106 of the electric vehicle 112, but delaying discharging the energy storage 106.

The control unit 102 shall provide a startup control signal allowing the electric vehicle 112 to discharge the energy storage 106 immediately when the frequency is on the lower side of the nominal value (and the voltage is within the permissible range) which will help the power grid 108 to increase frequency by adding generation to the power grid 108. That is, if the first data indicates that the frequency of the power grid 108 is below the lower frequency threshold, the startup control signal indicates that the energy storage 106 should, for the first waiting period, supply power to the power grid 108 and not draw power from the power grid 108, allowing discharging the energy storage 106 of the electric vehicle 112, but delaying charging the energy storage 106.

The electric power supply device 104 may continuously monitor the voltage and frequency of the exchanged electric power at the connection point 110 from the moment that the electric power supply device 104 is powered up, even when the electric vehicle 112 is not connected.

The control unit may consider other disturbed conditions of the power grid 108 such that the control unit 102 shall provide a startup control signal to the electric power supply device 104 based on the below table I:

TABLE I

| Frequency | Voltage | Allowed function |
|---|---|---|
| Within Normal range | Within Normal range | Allow charge or discharge as |
| | | desired |
| Grid Frequency > Upper | Within Normal range | Allow charge |
| threshold | | |
| Grid Frequency < lower | Within Normal range | Allow discharge |
| threshold | | |
| Grid Frequency > Upper | Grid Voltage > Upper | Allow charge |
| threshold | threshold | |
| Grid Frequency < lower | Grid Voltage > Upper | Do not allow, continue |
| threshold | threshold | monitoring |
| Grid Frequency > Upper | Grid Voltage < lower | Do not allow, continue |
| threshold | threshold | monitoring |
| Grid Frequency < lower | Grid Voltage < lower | Allow discharge |
| threshold | threshold | |
| Within Normal range | Grid Voltage > Upper | Allow charge |
| | threshold | |
| Within Normal range | Grid Voltage < lower | Allow discharge |
| | threshold | |
| Outside Normal range | Outside Normal range | Do not allow, continue |
| | | monitoring |

The first column of table I corresponds to the frequency of the power grid 108, the second column to the voltage of the power grid 108 and the third column shows the operation allowed by the generated startup control signal that corresponds to the combination of frequency and voltage of the corresponding row. For instance, if both the frequency and the voltage of the power grid 108 are respectively above the higher frequency threshold and the higher voltage threshold, the control unit 102 may generate a startup control signal allowing the energy storage 106 to charge from the power grid 108 but not to discharge. However, if the frequency of the power grid 108 is below the lower frequency threshold and the voltage of the power grid 108 is above the higher voltage threshold, the control unit 102 may generate a startup control signal not allowing the energy storage 106 to charge power from the power grid 108 neither discharge power from the power grid 108.

The below table II provides some examples of ranges and possible default setting for the observation period, the higher frequency threshold, the lower frequency threshold, the higher voltage threshold, and the lower voltage threshold. However, these ranges and values are not limiting, and any other suitable values and ranges may be used.

TABLE II

| | | Default | |
|---|---|---|---|
| Parameter | Range | setting | |
| Lower frequency | 47.0 Hertz | 49.5 | Hz |
| threshold | (HZ)-50.0 Hz | | |
| Higher frequency | 50.0 Hz-52.0 Hz | 50.1 | Hz |
| threshold | | | |
| Lower voltage | 50%-100% Un | 85% | Un |
| threshold | | | |
| Higher voltage | 100%-120% | 110% | Un |
| threshold | | | |
| Observation | 10 seconds-600 | 60 | seconds |

| | |
|---|---|
| period | seconds |

The frequency range, the voltage range, and the observation time shall be adjustable in the range according to table I, second column. If no settings are specified by the operator of the power grid, the default settings for connection or starting to generate electrical power due to normal operational startup or activity are according to table I, third column. ‘Un’ refers to Nominal Voltage, for EU, the nominal voltage is 230 Vac. i.w., 230 V refers to 100% Un.

The electric vehicle 112 of FIG. 1 comprises the energy storage 106 and a vehicle control unit 130 configured to, when the electric vehicle 112 has just been connected to the electric power supply device 104, receive the startup control signal generated by a control unit 102 of the electric power supply device 104 and to control the energy storage 106 based on the startup control signal. The startup control signal may indicate to the energy storage 106 one of starting exchange of electric power in any direction with the power grid, supply power to the power grid and not draw power from the power grid for a first waiting period or draw power from the power grid and not supply power to the power grid for a second waiting period. The first and second waiting times correspond to the amount of time needed by the power grid to restore the frequency to be within the frequency limitations.

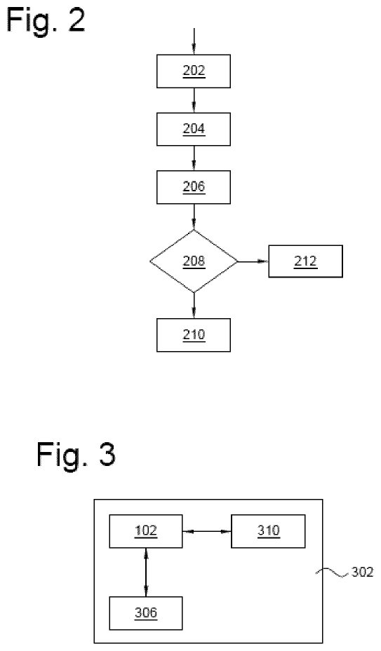

FIG. 2 shows a flowchart of a method for controlling an electric power supply device 104, the electric power supply device 104 being configured for power supply between an energy storage 106 and a power grid 108 which supplies electric power to a connection point 110.

In step 202, the method of FIG. 2 receives first data indicative of if the energy storage 106 is connected to the electric power supply device 104. In step 204, the method of FIG. 2 detects, using the first data, that the energy storage 106 is connected to the electric power supply device 104.

After detecting, in step 204, that the energy storage 106 is connected to the electric power supply device 104, the method proceeds to step 206 and obtains second data indicative of a frequency and a voltage of an exchanged electric power at the connection point 110 for an observation period.

In step 208, the method determines, using the second data, if both the frequency has been maintained within frequency limitations, and the voltage has been maintained within voltage limitations, for an observation period.

The second data indicative of the frequency and the voltage of the exchanged electric power at the connection point for the observation may be obtained based on a plurality of frequency and voltage measurements of the exchanged electric power taken during the observation period. The method of FIG. 2 may be, continuously monitoring the power grid. For instance, the method of FIG. 2 may be continuously measuring or continuously receiving measurements of frequency and/or voltage of exchanged power. The measured voltage and frequency may be stored in an internal memory and, upon detecting that the energy storage is connected to the electric power supply device, the method in step 208 may determine, based on the stored measurements, whether the frequency and/or the voltage have been maintained within frequency and/or voltage limitations for an observation period prior to the connection of the energy storage.

After determining in step 208 that both the frequency has been maintained within the frequency limitations, and the voltage has been maintained within the voltage limitations for the observation period, the method proceeds to step 210 and provides a startup control signal to the electric power supply device 104 indicating that the energy storage 106 is allowed to exchange electric power with the power grid 108.

If the method determines in step 208 that the frequency has not been maintained within the frequency limitations, the method proceeds to step 212 and generates the startup control signal indicating that the energy storage 106 should supply power to the power grid 108 and not draw power from the power grid 108 for a first waiting period, or draw power from the power grid 108 and not supply power to the power grid 108 for a second waiting period.

FIG. 3 illustrates a block diagram of an apparatus 302 for an electric power supply device 104 comprising the control unit 102 configured to perform the method of FIG. 2. The apparatus 302 may comprise a control unit 102, a memory 306, and a communication unit 310. The control unit 102 may comprise a Central Processing Unit, CPU, which is connected to the memory 306, the communication unit 310.

The memory 306 may comprise any suitable known memory devices to store data and/or instructions to be run on the control unit 102, and may include any known type of volatile and non-volatile memory equipment, Random Access Memory (RAM) and Read Only Memory (ROM) types of memories, etc. The memory may be used to store the plurality of measurements to be used to determine whether the frequency and/or voltage of the power grid is within the frequency and/or voltage limitations.

The communication unit 310 is configured to transmit signals to and receive signals from equipment outside the control unit 102 such as the electric vehicle 112 or the measurement device 114. Any known and suitable transceiver equipment can be used for that purpose using any known or still to be developed (standard) communication technique including 2G, 3G, 4G, 5G, Wifi, Bluetooth, Near Field Communication (NFC), etc. To that end the communication unit 310 may be connected to a network and an antenna.

While the present disclosure has been described with reference to exemplary embodiments, it will be understood by those skilled in the art that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to the particular embodiments disclosed, but that the present disclosure will include all embodiments falling within the scope of the appended claims.

As used herein, the terms “example” and/or “exemplary” mean serving as an example, instance, or illustration. For the avoidance of doubt, such examples do not limit the herein described subject matter. In addition, any aspect or design described herein as an “example” and/or “exemplary” is not necessarily preferred or advantageous over other aspects or designs, nor does it preclude equivalent exemplary structures and techniques known to those of ordinary skill in the art.

As used herein, the terms “first,” “second,” “third,” and the like in the description and in the claims, if any, distinguish between similar elements and do not necessarily describe a particular sequence or chronological order. The terms are interchangeable under appropriate circumstances such that the embodiments herein are, for example, capable of operation in sequences other than those illustrated or otherwise described herein. Furthermore, the terms “include,” “have,” and any variations thereof, cover a non-exclusive inclusion such that a process, method, system, article, device, or apparatus that comprises a list of elements is not necessarily limiting to those elements, but may include other elements not expressly listed or inherent to such process, method, system, article, device, or apparatus.

No element act, or instruction used herein is critical or essential unless explicitly described as such. Furthermore, the term “set” includes items (e.g., related items, unrelated items, a combination of related items and unrelated items, etc.) and may be interchangeable with “one or more”. Where only one item is intended, the term “one” or similar language is used. Also, the terms “has,” “have,” “having,” or the like are open-ended terms. Further, the phrase “based on” means “based, at least in part, on” unless explicitly stated otherwise.

As used herein, the terms “system,” “device,” “unit,” and/or “module” refer to a different component, component portion, or component of the various levels of the order. However, other expressions that achieve the same purpose may replace the term.

As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances. As used herein, the term “or” means an inclusive “or” rather than an exclusive “or.” That is, unless specified otherwise, or clear from context, “X uses A or B” means any of the natural inclusive permutations. That is, if X uses A; X uses B; or X uses both A and B, then “X uses A or B” is satisfied under any of the foregoing instances.

As used herein, the term “one of A, B, and C” shall be understood to mean “only A, only B, or only C,” and not a combination of A, B, and C.

As used herein, the term “one or more of A, B, and C” shall be understood to mean any one of A, B, or C, or any combination thereof, including multiple occurrences of each element. This includes, but is not limited to, the following configurations: only A, only B, only C, A and B, A and C, B and C, A, B, and C, as well as multiple instances of A, multiple instances of B, multiple instances of C, or any combination of multiple instances of A, B, and C.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Aspects of the one or more embodiments described herein are described with reference to flowchart illustrations and/or block diagrams of methods, apparatus (systems), and computer program products according to one or more embodiments described herein. Each block of the flowchart illustrations and/or block diagrams, and combinations of blocks in the flowchart illustrations and/or block diagrams, can be implemented by machine-readable storage program instructions. These computer-readable program instructions can be provided to a processor of a general purpose computer, special purpose computer and/or other programmable data processing apparatus to produce a machine, such that the instructions, which execute via the processor of the computer or other programmable data processing apparatus, for implementing the functions/acts specified in the flowchart and/or block diagram block or blocks. These computer-readable program instructions can also be stored in a computer-readable storage medium that can direct a computer, a programmable data processing apparatus and/or other devices to function in a particular manner, such that the computer-readable storage medium having instructions stored therein can comprise an article of manufacture including instructions which can implement aspects of the function/act specified in the flowchart and/or block diagram block or blocks. The computer-readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software product.

Other specific forms may embody the present disclosure without departing from its spirit or characteristics. The described embodiments are in all respects illustrative and not restrictive. Therefore, the appended claims rather than the description herein indicate the scope of the disclosure. All variations which come within the meaning and range of equivalency of the claims are within their scope.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

1. A control unit, configured to:
receive first data indicative of an energy storage connected to an electric power supply device;
detect, using the first data, that the energy storage is connected to the electric power supply device;
obtain second data indicative of a frequency and a voltage of an exchanged electric power at a connection point for an observation period;
determine, using the second data, that both the frequency has been maintained within frequency limitations, and the voltage has been maintained within voltage limitations during the observation period;
provide a startup control signal to the electric power supply device indicating that the energy storage is allowed to exchange electric power with a power grid;
wherein the control unit is used for controlling the electric power supply device;
wherein the electric power supply device is configured for power supply between the energy storage and power grid; and
wherein the power grid is used for supplying electric power to the connection point.

2. A method comprising:
receiving first data indicative of an energy storage connected to an electric power supply device;
detecting, using the first data, that the energy storage is connected to the electric power supply device;
obtaining second data indicative of a frequency and a voltage of an exchanged electric power at a connection point for an observation period;
determining, using the second data, that both the frequency has been maintained within frequency limitations, and the voltage has been maintained within voltage limitations, for the observation period;
providing a startup control signal to the electric power supply device indicating that the energy storage is allowed to exchange electric power with a power grid;
wherein the electric power supply device is configured for power supply between the energy storage and the power grid;
wherein the power grid is used for supplying electric power to the connection point; and
wherein the method is configured for controlling the electric power supply device.

3. The control unit of claim 1, wherein when the second data indicates that the frequency of the power grid has not been maintained within a frequency limitations for the observation period, the startup control signal indicates that the energy storage should supply power to the power grid and not draw power from the power grid for one of a first waiting period, draw power from the power grid and not supply power to the power grid for a second waiting period.

4. The control unit of claim 3, wherein the second data indicative of the frequency and the voltage of the exchanged electric power at the connection point for the observation period is obtained based on a plurality of frequency and voltage measurements of the exchanged electric power taken during the observation period.

5. The control unit of claim 4, wherein the frequency has been maintained within the frequency limitations after determining that an average of the plurality of frequency measurements is between a higher frequency threshold and a lower frequency threshold, and when a number of the plurality of measurement are between the higher frequency threshold and the lower frequency threshold, and wherein the voltage has been maintained within the voltage limitations after determining that an average of the plurality of voltage measurements is between a higher voltage threshold and a lower voltage threshold, and when another number of the plurality of voltage measurements are between the higher voltage threshold and the lower voltage threshold.

6. The control unit of claim 5, wherein one of the average of the plurality of frequency measurements and at least one of the plurality of frequency measurements is above the higher frequency threshold, the startup control signal indicates that the energy storage should, for the second waiting period, draw power from the power grid and not supply power to the power grid.

7. The control unit of claim 5, wherein one of the average of the plurality of frequency measurements and at least one of the plurality of frequency measurements is below the lower frequency threshold, the startup control signal indicates that the energy storage should, for the first waiting period, supply power to the power grid and not draw power from the power grid.

8. The control unit of claim 4, wherein the plurality of frequency and voltage measurements are taken by a measurement device connected to the connection point or by the electric power supply device.

9. The control unit of claim 1, wherein the electric power supply device is configured for bidirectional power supply between the energy storage and the power grid and, after determining that both the frequency has been maintained within the frequency limitations, and the voltage has been maintained within the voltage limitations for the observation period, the startup control signal indicates that the energy storage is allowed to bidirectionally exchange electric power with the power grid.

10. The control unit of claim 3, wherein the first waiting period and the second waiting period are based on an amount of time needed by the power grid to restore the frequency within the frequency limitations.

11. The control unit of claim 1, wherein the energy storage is arranged at an electric vehicle.

12. The control unit of claim 1, wherein the observation period comprises a period before detecting that the energy storage is connected to the electric power supply device.

13. The control unit of claim 5, wherein the higher frequency threshold is greater than the lower frequency threshold and the higher voltage threshold is greater than the lower voltage threshold.

14. The control unit of claim 5, wherein the energy storage is configured to restore the frequency at the power grid when the frequency is above the higher frequency threshold.

15. The control unit of claim 1, wherein the electric power supply device is configured to continuously monitor the frequency and the voltage of the exchanged electric power at the connection point.

16. The control unit of claim 15, wherein the frequency and the voltage are measured inside the electric power supply device by one of a power board measuring circuit and a measurement device.

17. The control unit of claim 1, wherein the control unit is connected through a communication line with the energy storage.

18. The control unit of claim 1, wherein the control unit further comprising a central processing unit connected to a memory unit and a communication unit.

19. An electric vehicle comprising an electric power supply device, wherein the electric power supply device further comprising a control unit for controlling the electric power supply device, wherein the control unit is configured to:
receive first data indicative of when an energy storage is connected to the electric power supply device;
detect, using the first data, that the energy storage is connected to the electric power supply device;
obtain second data indicative of a frequency and a voltage of an exchanged electric power at a connection point for an observation period;
determine, using the second data, that both the frequency has been maintained within frequency limitations, and the voltage has been maintained within voltage limitations during the observation period;
provide a startup control signal to the electric power supply device indicating that the energy storage is allowed to exchange electric power with a power grid;
wherein the control unit is used for controlling the electric power supply device;
wherein the electric power supply device is configured for power supply between the energy storage and power grid; and
wherein the power grid is used for supplying electric power to the connection point.

20. The electric vehicle of claim 19, wherein the electric vehicle comprising a Direct Current to Alternate current converter.
